(19) United States
(12) Patent Application Publication
(10) Pub. No.: US 2016/0104414 A1
(43) Pub. Date: Apr. 14, 2016

(54) DISPLAY DEVICE AND METHOD OF DRIVING THE SAME

(71) Applicant: Samsung Display Co., Ltd., Yongin-City (KR)

(72) Inventors: Kihyun PYUN, Gwangmyeong-si (KR); Tongill KWAK,, Cheonan-si (KR); Heebum PARK, Seongnam-si (KR)

(21) Appl. No.: 14/698,346

(22) Filed: Apr. 28, 2015

(30) Foreign Application Priority Data
Oct. 14, 2014 (KR) 10-2014-0138445

(51) Int. Cl. G09G 3/20

(52) U.S. Cl. CPC G09G 3/2092; G09G 2320/04

(57) ABSTRACT

A display device includes a timing controller configured to output driving signals and image signals in response to an external control signal, a data driver configured to receive the image signals and convert the image signals to data voltages, and a display panel including pixels configured to display an image based on the data voltages. The timing controller is further configured to detect a counted value of pulses of one selection driving signal of the driving signals, determine one selection frequency of reference frequencies, and apply the image signals to the data driver based on the selection frequency.

### CROSS-REFERENCE TO RELATED APPLICATION

This U.S. non-provisional patent application claims priority under 35 U.S.C. §119 of Korean Patent Application No. 10-2014-0138445, filed on Oct. 14, 2014, the contents of which are hereby incorporated by reference.

### BACKGROUND

1. Field of disclosure

The present disclosure relates to a display device and a method of driving the same. More particularly, the present disclosure relates to a display device capable of reducing an electromagnetic interference (EMI) and a method of driving the display device.

2. Description of the Related Art

A display device includes a display panel for displaying an image and gate and data drivers for driving the display panel. The display panel includes gate lines, data lines, and pixels, wherein each of the pixels is connected to a corresponding gate line of the gate lines and a corresponding data line of the data lines. The gate lines receive gate signals from the gate driver. The data lines receive data voltages from the data driver. The pixels receive the data voltages through the data lines in response to the gate signals provided through the gate lines. The pixels display grayscales corresponding to the data voltages to thereby display an image.

In addition, the display device includes a timing controller for controlling the gate driver and the data driver. The timing controller generates driving signals to control the gate driver and the data driver in response to an external control signal. The timing controller applies a data driving signal and image signals to the data driver using an interface operation.

In recent years, the interface operation speed between the timing controller and the data driver has increased, and as a consequence, an electromagnetic interference (EMI) occurs.

### SUMMARY

The present disclosure provides a display device capable of reducing an electromagnetic interference during an interface operation between a timing controller and a data driver.

The present disclosure provides a method of driving the display device.

Embodiments of the present system and method provide a display device including a timing controller configured to output a plurality of driving signals and a plurality of image signals in response to an external control signal, a data driver configured to receive the image signals and convert the image signals to a plurality of data voltages, and a display panel including a plurality of pixels configured to display an image in response to the data voltages. The timing controller is further configured to detect a counted value obtained by counting pulses of one selection driving signal of the driving signals, determine one selection frequency of a plurality of reference frequencies in accordance with the counted value, and apply the image signals to the data driver based on the selection frequency.

The display device further includes a gate driver configured to receive the selection driving signal and output a plurality of gate signals in response to the selection driving signal, and the pixels are configured to receive the data voltages in response to the gate signals.

The selection driving signal is a vertical start signal for activating the gate driver every frame period, and the gate driver is configured to sequentially output the gate signals in response to the vertical start signal.

The timing controller includes a driving signal generator configured to output the driving signals in response to the external control signal, a counter comparator configured to detect the counted value obtained by counting the pulses of the selection driving signal and output one selection bit signal among a plurality of bit signals in response to the counted value, and a multiplexer configured to select the selection frequency of the reference frequencies in response to the selection bit signal.

The timing controller further includes a receiver configured to output the image signals in response to the selection frequency, and the receiver includes a phase-locked loop configured to control an output of the image signals based on the selection frequency.

The counter comparator is configured to reset the counted value when the counted value obtained by counting the pulses of the selection driving signal is greater than a predetermined counted value.

Embodiments of the present system and method provide a display device including a timing controller configured to output a plurality of driving signals and a plurality of image signals in response to an external control signal, a data driver configured to receive the image signals and convert the image signals to a plurality of data voltages, and a display panel including a plurality of pixels configured to display an image in response to the data voltages. The timing controller includes a receiver configured to apply the image signals to the data driver, detect a counted value obtained by counting pulses of one selection driving signal of the driving signals, and output a first selection signal or a second selection signal in accordance with the counted value. The receiver includes a first phase-locked loop configured to output the image signals based on a first reference frequency in response to the first selection signal and a second phase-locked loop configured to output the image signals based on a second reference frequency in response to the second selection signal.

The timing controller includes a driving signal generator configured to output the driving signals in response to the external control signal and a counter comparator configured to detect the counted value obtained by counting the pulses of the selection driving signal and output the first selection signal or the second selection signal based on the counted value.

The counter comparator is configured to output the first selection signal when the counted value is equal to or smaller than a first counted value and output the second selection signal when the counted value is greater than the first counted value and equal to or smaller than a second counted value.

The counter comparator is configured to reset the counted value when the counted value is greater than the second counted value.

The display device further includes a gate driver configured to receive the selection driving signal and output a plurality of gate signals in response to the selection driving signal. The pixels are configured to receive the data voltages in response to the gate signals.

The selection driving signal is a vertical start signal for activating the gate driver every frame period, and the gate driver is configured to sequentially output the gate signals in response to the vertical start signal.

Embodiments of the system and method provide a method of driving the display device including a timing controller interfacing with a data driver, including outputting a plurality of driving signals in response to an external control signal, detecting a counted value obtained by counting pulses of one selection driving signal of the driving signals, outputting one selection bit signal of a plurality of bit signals in accordance with the counted value, determining one selection frequency of a plurality of reference frequencies in response to the selection bit signal, and providing the image signals from the timing controller to the data driver based on the selection frequency.

The method further includes resetting the counted value when the counted value is greater than a predetermined counted value.

The timing controller includes a phase-locked loop to provide the image signals to the data driver based on the selection frequency.

According to the above, the driving reliability of the display device is improved.

### BRIEF DESCRIPTION OF THE DRAWINGS

The above and other advantages of the present disclosure are further described below with reference to the accompanying drawings wherein:

FIG. 1 is a block diagram showing a display device according to an exemplary embodiment of the present disclosure;

FIG. 2 is a block diagram showing a timing controller shown in FIG. 1.

FIG. 3 is a timing diagram showing an output of gate voltages in accordance with a driving signal output from a driving signal generator shown in FIG. 2;

FIG. 4 is a table showing a selection bit signal in accordance with a counted value by a counter comparator shown in FIG. 2;

FIG. 5 is a table showing a reference frequency selected in accordance with the selection bit signal among reference frequencies when a multiplexer shown in FIG. 2 is operated;

FIG. 6 is a flowchart showing a method of driving the timing controller according to an exemplary embodiment of the present disclosure;

FIG. 7 is a block diagram showing a timing controller according to another exemplary embodiment of the present disclosure; and

FIG. 8 is a table showing a selection signal in accordance with a counted value by a counter comparator shown in FIG. 7.

### DETAILED DESCRIPTION

As used herein, when an element or layer is referred to as being “on”, “connected to” or “coupled to” another element or layer, it may be directly on, connected or coupled to the other element or layer, or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Although the terms “first,” “second,” etc. may be used herein to describe various elements, components, regions, layers and/or sections, these elements, components, regions, layers and/or sections are not limited by these terms. These terms are only used to distinguish one element, component, region, layer or section from another region, layer or section. Thus, a first element, component, region, layer or section discussed below can also be referred to as a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations), and thus, the spatially relative descriptors used herein should be interpreted accordingly.

The terminology used herein for the purpose of describing particular embodiments is not limiting of the disclosure. As used herein, the singular forms, “a”, “an” and “the” include the plural forms as well, unless the context clearly indicates otherwise. Furthermore, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the meaning as commonly understood by one of ordinary skill in the art to which this disclosure pertains. For example, terms, including those defined in commonly used dictionaries, are to be interpreted as having a meaning that is consistent with their meaning in the context of the relevant art unless expressly defined herein.

Hereinafter, the present disclosure is explained in detail with reference to the accompanying drawings.

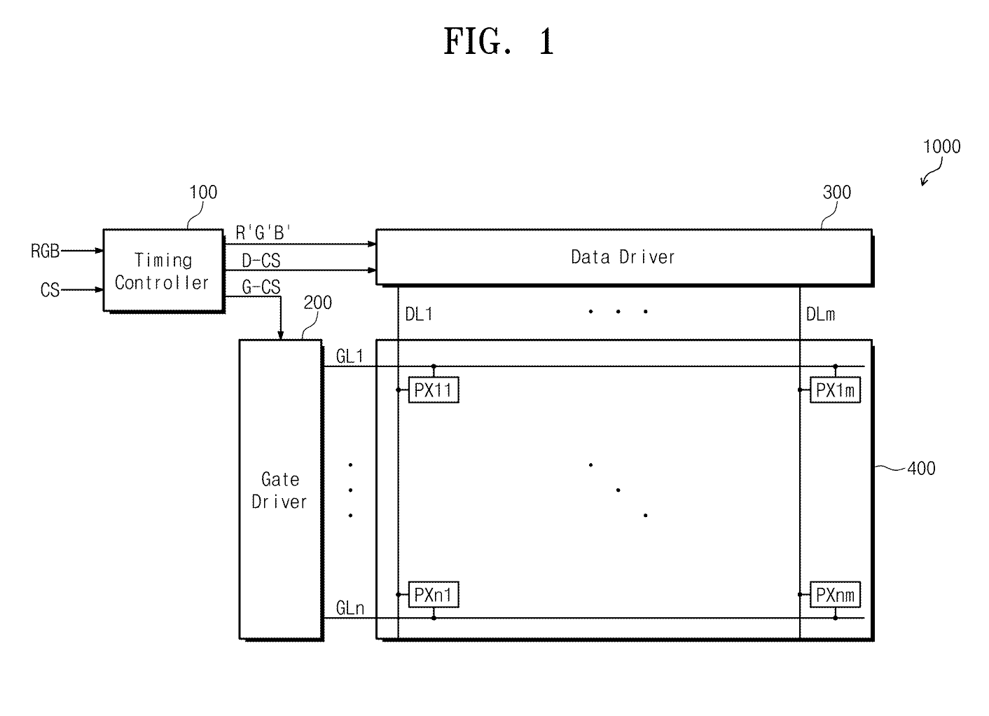

FIG. 1 is a block diagram showing a display device 1000 according to an exemplary embodiment of the present disclosure. Referring to FIG. 1, the display device 1000 includes a timing controller 100, a gate driver 200, a data driver 300, and a display panel 400.

The timing controller 100 receives a plurality of image signals RGB and a plurality of control signals CS from a source (not shown) external to the display device 1000. The timing controller 100 converts the data format of the image signals RGB to a data format appropriate for interfacing between the data driver 300 and the timing controller 100. The image signals R′G′B′ having the converted data format are applied to the data driver 300.

The timing controller 100 outputs a plurality of driving signals in response to the control signals CS. The timing controller 100 generates a data driving signal D-CS and a gate driving signal G-CS as the driving signals. For instance, the data driving signal D-CS may include an output start signal, a horizontal start signal, etc. The gate driving signal G-CS may include a vertical start signal, a vertical clock bar signal, etc. The timing controller 100 applies the data driving signal D-CS to the data driver 300 and applies the gate driving signal G-CS to the gate driver 200.

According to an exemplary embodiment, the timing controller 100 transmits the image signals R′G′B′ and the data driving signal D-CS in accordance with a plurality of reference frequencies, instead of a fixed reference frequency, when the timing controller 100 interfaces with the data driver 300.

The gate driver 200 generates a plurality of gate signals in response to the gate driving signal G-CS provided from the timing controller 100. The gate driver 200 sequentially outputs the gate signals to the display panel 400 through a plurality of gate lines GL1 to GLn. The display panel 400 includes a plurality of pixels PX11 to PXnm, which are sequentially scanned by row in response to the gate signals.

The data driver 300 converts the image signals R′G′B′ to a plurality of data voltages in response to the data driving signal D-CS provided from the timing controller 100. The data driver 300 applies the data voltages to the display panel 400 through a plurality of data lines DL1 to DLm.

The display panel 400 includes the gate lines GL1 to GLn, the data lines DL1 to DLm, and the pixels PX11 to PXnm.

The gate lines GL1 to GLn extend in a row direction and cross the data lines DL1 to DLm extending in a column direction. The gate lines GL1 to GLn are electrically connected to the gate driver 200 and receive the gate signals. The data lines DL1 to DLm are electrically connected to the data driver 300 and receive the data voltages. Each of the pixels PX11 to PXnm is connected to a corresponding gate line of the gate lines GL1 to GLn and a corresponding data line of the data lines DL1 to DLm.

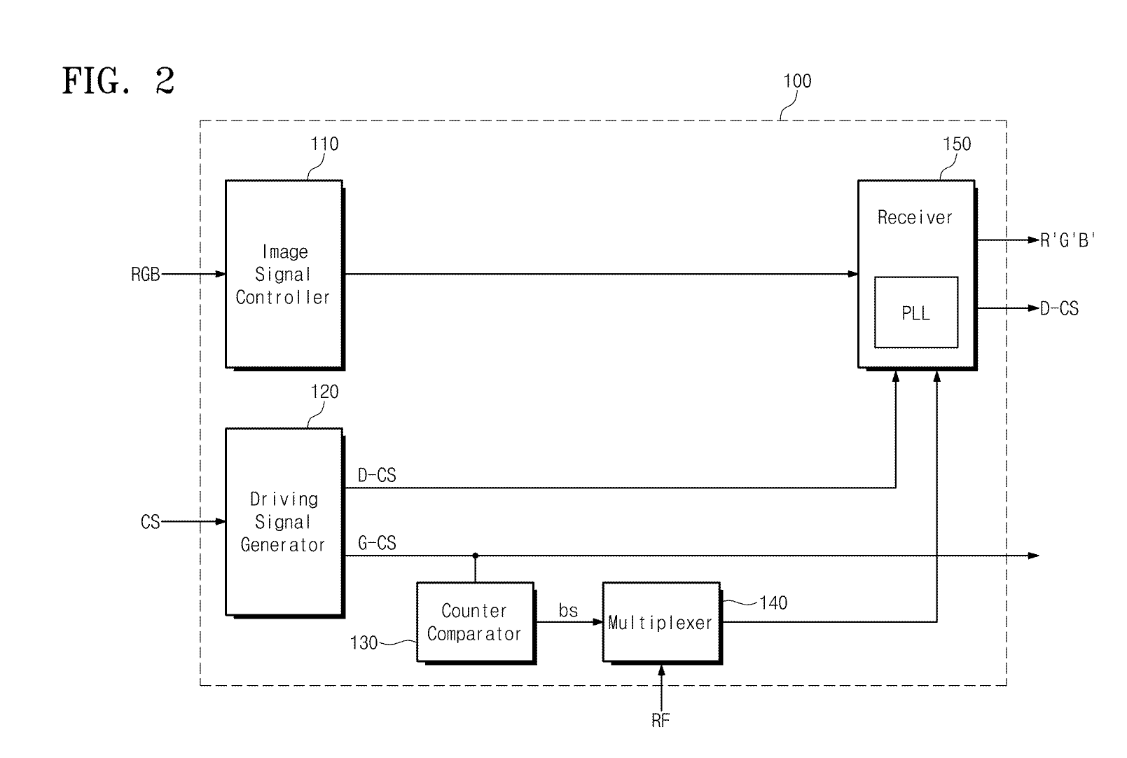

FIG. 2 is a block diagram showing the timing controller shown in FIG. 1. Referring to FIG. 2, the timing controller 100 includes an image signal controller 110, a driving signal generator 120, a counter comparator 130, a multiplexer 140, and a receiver 150.

The image signal controller 110 receives the image signals RGB from outside of the display device 1000. The image signal controller 110 controls the image signals RGB for interfacing with the data driver 300. For example, the image signal controller 110 converts the image signals RGB to the image signals R′G′B′ so that the data format of the image signals R′G′B′ meets the resolution of the display panel 400.

The driving signal generator 120 receives the control signals CS from outside of the display device 1000. The driving signal generator 120 generates the data driving signal D-CS and the gate driving signal G-CS in response to the control signals CS. The driving signal generator 120 applies the gate driving signal G-CS to the gate driver 200 and counter comparator 130 and applies the data driving signal D-CS to the receiver 150.

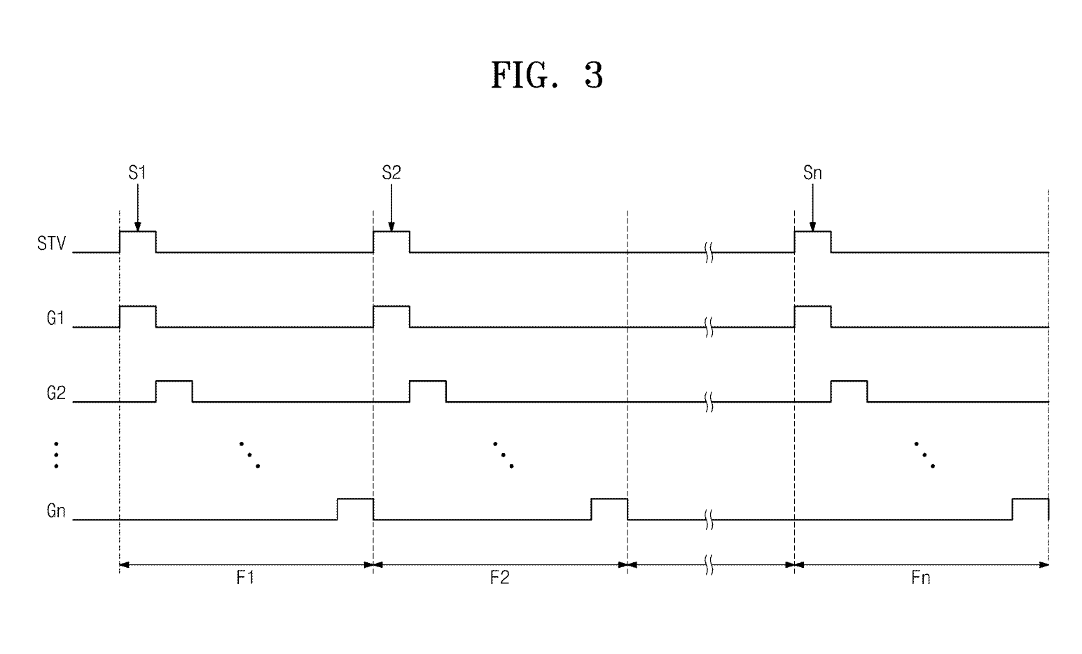

The counter comparator 130 receives the gate driving signal G-CS output from the driving signal generator 120. As described with reference to FIG. 1, the gate driving signal G-CS includes the vertical start signal STV (refer to FIG. 3), the vertical clock bar signal, etc. Although the counter comparator 130 may receive the vertical start signal STV from the driving signal generator 120, the present system and method is not limited thereto. That is, the driving signal generator 120 may apply one driving signal of the driving signals to the counter comparator 130.

According to the exemplary embodiment of FIG. 2, the counter comparator 130 outputs a selection bit signal bs in accordance with the number of pulses of the vertical start signal STV.

The multiplexer 140 receives the selection bit signal bs from the counter comparator 130. The multiplexer 140 provides one reference frequency, which is selected among a plurality of reference frequencies RF, to the receiver 150 in response to receiving the selection bit signal bs.

The receiver 150 receives the image signals RGB from the image signal controller 110, the data driving signal D-CS from the driving signal generator 120, and the selection frequency from the multiplexer 140. The receiver 150 may include a phase-locked loop (hereinafter, referred to as PPL) to synchronize the selection frequency with a frequency (phase) of the clocks used in the data driver 300. The receiver 150 transmits the image signals R′G′B′ and the data driving signal D-CS to the data driver 30 based on the selection frequency provided from the multiplexer 140.

When the receiver 150 interfaces with the data driver 300 to transmit the image signals R′G′B′ and the data driving signal D-CS to the data driver 300, an electromagnetic interference (EMI) may occur in a specific frequency range and cause noise in the image.

In a conventional timing controller, the receiver transmits the image signals R′G′B′ and the data driving signal D-CS to the data driver based on a fixed reference frequency. This causes a high frequency to be momentarily generated within the specific frequency range. As a result, electromagnetic interference (EMI) occurs when the receiver interfaces with the data driver.

In contrast, according to an exemplary embodiment of the present system and method, the timing controller 100 transmits and/or receives the data in accordance with a plurality of frequencies, instead of a fixed frequency, when the timing controller 100 interfaces with the data driver 300. In this manner, the high frequency generated within the specific frequency range and the electromagnetic interference (EMI) may be reduced when the timing controller 100 interfaces with the data driver 300.

FIG. 3 is a timing diagram showing an output of the gate voltages in accordance with the vertical start signal output from the driving signal generator shown in FIG. 2. Referring to FIGS. 2 and 3, the gate driver 200 (refer to FIG. 1) receives the vertical start signal STV output from the driving signal generator 120. The vertical start signal STV is used to control the output of the gate signals G1 to Gn from the gate driver 200. That is, the gate driver 200 sequentially outputs the gate signals G1 to Gn during each of the frame periods F1 to Fn in response to the vertical start signal STV. One image is displayed during each of the frame periods F1 to Fn.

Referring to FIG. 3, in each of the frame periods F1 to Fn, the vertical start signal STV transitions to an activation voltage level substantially simultaneously with a first gate signal G1, but the present system and method are not limited thereto. That is, the vertical start signal STV may transition to the activation voltage level in a previous frame period before the first gate signal G1 is activated.

Then, when the first gate signal G1 transitions to a non-activation voltage level, the gate driver 200 outputs a second gate signal G2 at the activation voltage level. That is, as the first gate signal G1 transitions to the non-activation voltage level, the second gate signal G2 following the first gate signal G1 transitions to the activation voltage level. As the above-described operation is repeatedly implemented, the gate signals G1 to Gn are sequentially output during a first frame period F1 in response to the vertical start signal STV.

As described above, the counter comparator 130 may receive the vertical start signal STV from the driving signal generator 120. The counter comparator 130 counts the number of pulses, each indicating that the vertical start signal STV is activated during the frame periods F1 to Fn. The vertical start signal STV is activated once, i.e., the activation pulse is generated once, in each of the frame periods F1 to Fn.

As an example, the vertical start signal STV includes one activation pulse in the first frame period F1, in which case the counter comparator 130 counts one activation pulse S1. Since the vertical start signal STV includes n activation pulses during the first to n-th frame periods F1 to Fn, the counter comparator 130 counts n activation pulses Sn. Here, “n” is a natural number. The counter comparator 130 outputs the selection bit signal bs in response to the counted value of pulses, each pulse indicating that the vertical start signal STV is activated.

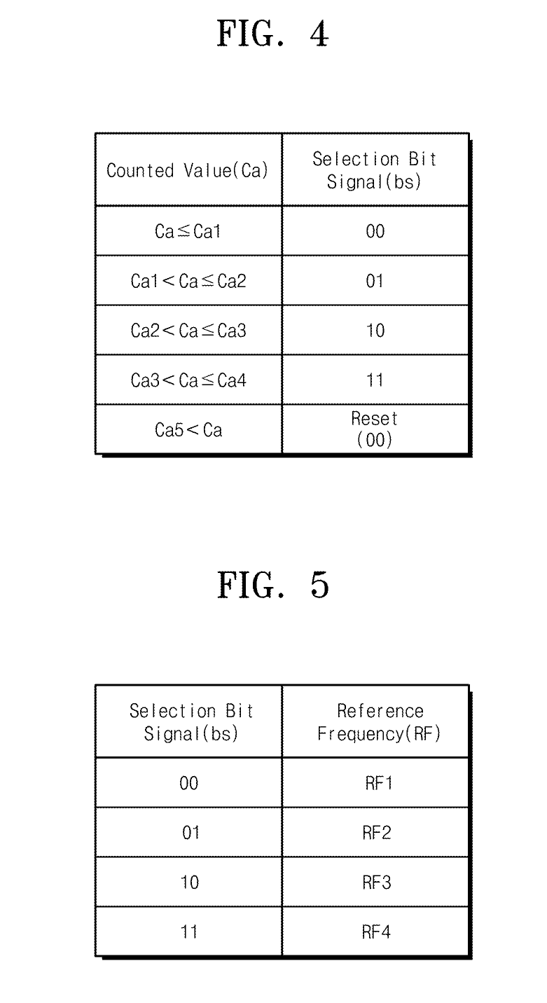

FIG. 4 is a table showing the selection bit signal in accordance with the counted value counted by the counter comparator shown in FIG. 2. Referring to FIGS. 2 to 4, the counter comparator 130 determines the value of the selection bit signal bs based on the counted value Ca of the number of pulses of the vertical start signal STV.

As an example, the counter comparator 130 outputs “00” for the selection bit signal bs when the counted value Ca of the number of pulses of the vertical start signal STV is equal to or smaller than a first counted value Ca1.

As an example, the counter comparator 130 outputs “01” for the selection bit signal bs when the counted value Ca of the number of pulses of the vertical start signal STV is greater than the first counted value Ca1 and equal to or smaller than a second counted value Ca2.

As an example, the counter comparator 130 outputs “10” for the selection bit signal bs when the counted value Ca of the number of pulses of the vertical start signal STV is greater than the second counted value Ca2 and equal to or smaller than a third counted value Ca3.

As an example, the counter comparator 130 outputs “11” for the selection bit signal bs when the counted value Ca of the number of pulses of the vertical start signal STV is greater than the third counted value Ca3 and equal to or smaller than a fourth counted value Ca4.

As an example, the counter comparator 130 resets the counted value Ca when the counted value Ca of the number of pulses of the vertical start signal STV is greater than a fifth counted value Ca5. After the reset, the counter comparator 130 outputs “00” for the selection bit signal bs.

Thus, according to the exemplary embodiment of FIG. 4, the counter comparator 130 outputs one of four different values for the selection bit signal bs based on the counted value Ca. The present system and method, however, are not limited to four different values for the selection bit signal. That is, the counter comparator 130 may output one among any number of different values for the selection bit signal bs.

FIG. 5 is a table showing the reference frequency selected in accordance with the selection bit signal among the reference frequencies when the multiplexer shown in FIG. 2 is operated. Referring to FIGS. 2 to 5, the multiplexer 140 selects a corresponding reference frequency RF in response to and based the value of the selection bit signal bs output from the counter comparator 130.

As an example, the multiplexer 140 selects a first reference frequency RF1 among the reference frequencies RF1 to RF4 when the counter comparator 130 outputs “00” for the selection bit signal bs.

As an example, the multiplexer 140 selects a second reference frequency RF2 among the reference frequencies RF1 to RF4 when the counter comparator 130 outputs “01” for the selection bit signal bs.

As an example, the multiplexer 140 selects a third reference frequency RF3 among the reference frequencies RF1 to RF4 when the counter comparator 130 outputs “10” the selection bit signal bs.

As an example, the multiplexer 140 selects a fourth reference frequency RF4 among the reference frequencies RF1 to RF4 when the counter comparator 130 outputs “11” for the selection bit signal bs.

As described above, the multiplexer 140 outputs the corresponding reference frequency RF (e.g., selected among the reference frequencies RF1 to RF4) to the receiver 150 based on the selection bit signal bs. Thus, the receiver 150 may interface with the data driver 300 based on the reference frequencies RF output from the multiplexer 140.

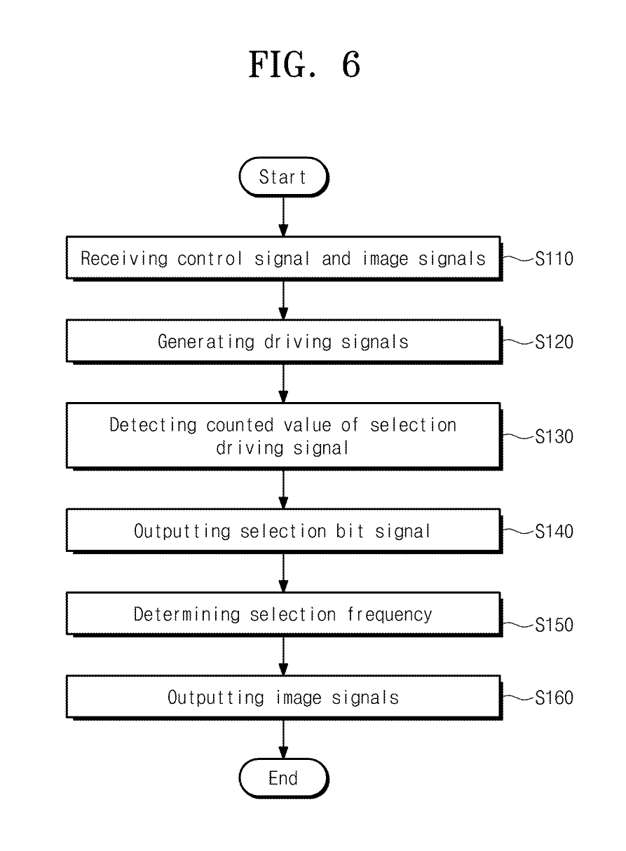

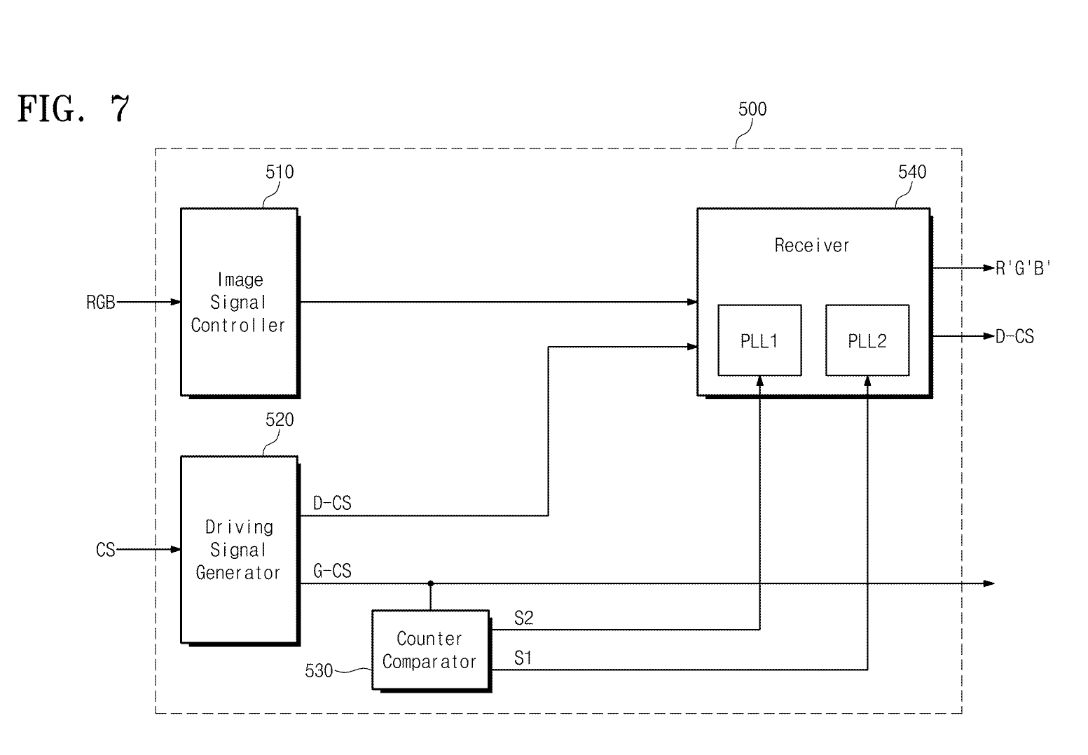

FIG. 6 is a flowchart showing a method of driving the timing controller according to an exemplary embodiment of the present disclosure.

Referring to FIGS. 2 and 6, the timing controller 100 receives the control signals CS and the image signals RGB from outside of the display device 1000 (S110).

The timing controller 100 generates the driving signals in response to the control signals CS (S120).

The timing controller detects the counted number of pulses of a selection driving signal of the driving signals (S130). For instance, the selection driving signal may be, but not limited to, the vertical start signal of the driving signals.

The timing controller 100 outputs the selection bit signal bs corresponding to the detected counted value (S140). The value of the selection bit signal may correspond to the counted value.

The timing controller 100 selects a reference frequency among the reference frequencies in response to and based on the value of the selection bit signal bs (S150).

The receiver 150 applies the image signals R′G′B′ and the data driving signal D-CS to the data driver 300 based on the selection reference frequency (S160).

That is, according to an embodiment of the present disclosure, the timing controller 100 transmits and/or receives the data using a variable reference frequency within a specific frequency range, instead of one fixed frequency, while interfacing with the data driver 300.

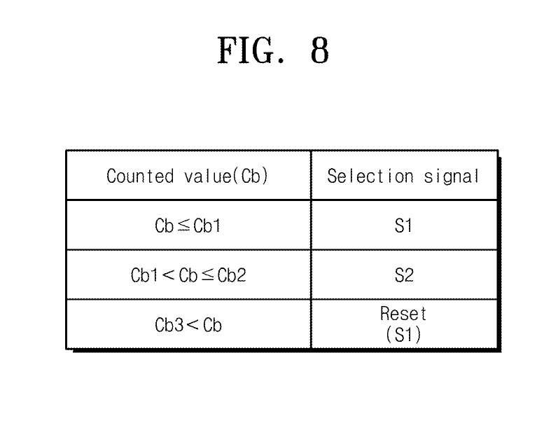

FIG. 7 is a block diagram showing a timing controller according to another exemplary embodiment of the present disclosure. Referring to FIG. 7, a timing controller 500 includes an image signal controller 510, a driving signal generator 520, a counter comparator 530, and a receiver 540.

The image signal controller 510 receives a plurality of image signals RGB from an external source (not shown). The image signal controller 510 controls the image signals RGB according to an interface specification with the data driver 300 (refer to FIG. 1). That is, the image signal controller 510 converts the data format of the image signals RGB to a data format appropriate for a resolution of the display panel 400 (refer to FIG. 1) and generates a plurality of image signals R′G′B′.

The driving signal generator 520 receives the control signals CS from the external source (not shown). The driving signal generator 520 generates a data driving signal D-CS and a gate driving signal G-CS in response to the control signals CS. The driving signal generator 520 applies the gate driving signal G-CS to the gate driver 200 (refer to FIG. 1) and the comparator 530 and applies the data driving signal D-CS to the receiver 540.

The counter comparator 530 receives the gate driving signal G-CS output from the driving signal generator 520. As described with reference to FIG. 1, the gate driving signal G-CS includes the vertical start signal STV (refer to FIG. 3), the vertical clock bar signal, etc. Although the counter comparator 530 may receive the vertical start signal STV of the gate driving signals G-CS from the driving signal generator 520, but the present system and method not limited thereto. That is, the driving signal generator 520 may apply one driving signal of the driving signals to the counter comparator 530.

The counter comparator 530 outputs a first selection signal S1 or a second selection signal S2 according to a counted number of pulses of the vertical start signal STV.

The receiver 540 receives the image signals RGB from the image signal controller 510 and the data driving signal D-CS from the driving signal generator 520. In addition, the receiver 540 receives the first selection signal S1 or the second selection signal S2 from the counter comparator 530.

According to the exemplary embodiment of FIG. 7, the receiver 540 includes a first phase-locked loop PLL1 and a second phase-locked loop PLL2 to synchronize a reference frequency thereof with a frequency (phase) of the clocks used in the data driver 300 when the receiver 540 interfaces with the data driver 300.

In detail, the receiver 540 applies the image signals R′G′B′ and the data driving signals D-CS to the data driver 300 based on the first phase-locked loop PPL1 when the counter comparator 530 outputs the first selection signal S1. The receiver 540 applies the image signals R′G′B′ and the data driving signals D-CS to the data driver 300 based on the second phase-locked loop PPL2 when the counter comparator 530 outputs the second selection signal S2.

That is, the timing controller 100 shown in FIG. 2 changes the reference frequency in accordance with the counted number of pulses of the vertical start signal STV by selecting the reference frequency among a plurality of reference frequencies while interfacing with the data driver 300. However, the timing controller 500 according to the exemplary embodiment of FIG. 7 changes the reference frequency by selecting one phase-locked loop of the first and second phase-locked loops PPL1 and PPL2 in accordance with the selection signals S1 and S2.

FIG. 8 is a table showing the selection signal in accordance with the counted number of pulses of the vertical start signal during an operation of the counter comparator shown in FIG. 7. Referring to FIGS. 7 and 8, the counter comparator 530 determines the first selection signal S1 or the second selection signal S2 based on the counted value Cb of the number of pulses of the vertical start signal STV.

As an example, the counter comparator 530 outputs the first selection signal S1 when the counted value Cb of the number of pulses of the vertical start signal STV is equal to or smaller than a first counted value Cb1. In this case, the receiver 540 interfaces with the data driver 300 using the first phase-locked loop PLL1.

As an example, the counter comparator 530 outputs the second selection signal S2 when the counted value Cb of the number of pulses of the vertical start signal STV is greater than the first counted value Cb1 and equal to or smaller than a second counted value Cb2. In this case, the receiver 540 interfaces with the data driver 300 using the second phase-locked loop PLL2.

As an example, the counter comparator 530 resets the counted value Cb when the counted value Cb of the number of pulses of the vertical start signal STV is greater than a third counted value Cb3. After the reset, the counter comparator 530 outputs the first selection signal S1.

Although exemplary embodiments of the present disclosure are described herein, the present disclosure is not limited to these exemplary embodiments. Rather, various changes and modifications can be made by one of ordinary skill in the art within the spirit and scope of the present disclosure.

What is claimed is:

1. A display device comprising:
a timing controller configured to output a plurality of driving signals and a plurality of image signals in response to an external control signal;
a data driver configured to receive the image signals and convert the image signals to a plurality of data voltages; and
a display panel comprising a plurality of pixels configured to display an image in response to the data voltages, wherein the timing controller is further configured to detect a counted value obtained by counting pulses of one selection driving signal of the driving signals, determine one selection frequency of a plurality of reference frequencies in accordance with the counted value, and apply the image signals to the data driver based on the selection frequency.

2. The display device of claim 1, further comprising a gate driver configured to receive the selection driving signal and output a plurality of gate signals in response to the selection driving signal, wherein the pixels are configured to receive the data voltages in response to the gate signals.

3. The display device of claim 2, wherein the selection driving signal is a vertical start signal for activating the gate driver every frame period, and the gate driver is configured to sequentially output the gate signals in response to the vertical start signal.

4. The display device of claim 1, wherein the timing controller comprises:
a driving signal generator configured to output the driving signals in response to the external control signal;
a counter comparator configured to detect the counted value obtained by counting the pulses of the selection driving signal and outputting one selection bit signal among a plurality of bit signals in response to the counted value; and
a multiplexer configured to select the selection frequency of the reference frequencies in response to the selection bit signal.

5. The display device of claim 4, wherein the timing controller further comprises a receiver configured to output the image signals in response to the selection frequency, and the receiver comprises a phase-locked loop configured to control an output of the image signals based on the selection frequency.

6. The display device of claim 4, wherein the counter comparator is configured to reset the counted value when the counted value obtained by counting the pulses of the selection driving signal is greater than a predetermined counted value.

7. A display device comprising:
a timing controller configured to output a plurality of driving signals and a plurality of image signals in response to an external control signal;
a data driver configured to receive the image signals and convert the image signals to a plurality of data voltages; and
a display panel comprising a plurality of pixels configured to display an image in response to the data voltages, wherein the timing controller further comprises a receiver configured to apply the image signals to the data driver, detect a counted value obtained by counting pulses of one selection driving signal of the driving signals, and output a first selection signal or a second selection signal in accordance with the counted value, and the receiver comprises a first phase-locked loop configured to output the image signals based on a first reference frequency in response to the first selection signal and a second phase-locked loop configured to output the image signals based on a second reference frequency in response to the second selection signal.

8. The display device of claim 7, wherein the timing controller comprises:
a driving signal generator configured to output the driving signals in response to the external control signal; and
a counter comparator configured to detect the counted value obtained by counting the pulses of the selection driving signal and output the first selection signal or the second selection signal based on the counted value.

9. The display device of claim 8, wherein the counter comparator is configured to output the first selection signal when the counted value is equal to or smaller than a first counted value and output the second selection signal when the counted value is greater than the first counted value and equal to or smaller than a second counted value.

10. The display device of claim 9, wherein the counter comparator is configured to reset the counted value when the counted value is greater than the second counted value.

11. The display device of claim 7, further comprising a gate driver configured to receive the selection driving signal and output a plurality of gate signals in response to the selection driving signal, wherein the pixels are configured to receive the data voltages in response to the gate signals.

12. The display device of claim 11, wherein the selection driving signal is a vertical start signal for activating the gate driver every frame period, and the gate driver sequentially outputs the gate signals in response to the vertical start signal.

13. A method of driving a display device comprising a timing controller interfacing with a data driver, comprising:
outputting a plurality of driving signals in response to an external control signal;
detecting a counted value obtained by counting pulses of one selection driving signal of the driving signals;
outputting one selection bit signal of a plurality of bit signals in accordance with the counted value;
determining one selection frequency of a plurality of reference frequencies in response to the selection bit signal; and
providing the image signals from the timing controller to the data driver based on the selection frequency.

14. The method of claim 13, further comprising resetting the counted value when the counted value is greater than a predetermined counted value.

15. The method of claim 13, wherein the timing controller comprises a phase-locked loop to provide the image signals to the data driver based on the selection frequency.
